(19) United States
(12) Patent Application Publication
(10) Pub. No.: US 2017/0244753 A1
(43) Pub. Date: Aug. 24, 2017

(54) ESTABLISHING A SECURE DATA EXCHANGE CHANNEL

(71) Applicant: Xuesong HU, San Jose, CA (US)

(72) Inventor: Xuesong HU, San Jose, CA (US)

(21) Appl. No.: 15/048,726

(22) Filed: Feb. 19, 2016

(51) Int. Cl. H04L 29/06; H04L 9/30; G06F 17/30; H04W 12/06; H04W 12/04; H04L 9/14; H04L 9/32

(52) U.S. Cl. CPC H04L 63/1466; H04L 9/14; H04L 9/30; H04L 9/3247; H04L 63/0428; H04L 63/06; H04L 63/0823; H04W 12/06; H04W 12/04; G06F 17/30867; H04L 2209/80

(57) ABSTRACT

A method is provided for verifying a data exchange channel between a first client, a second client, and a server that is communicatively coupled to the first client and the second client, respectively. The first client exchanges a sequence of updates to an information item with the second client through the data exchange channel and each of the first client, the second client, and the server maintains a respective copy of update sequence history of the information item. First, the first client sends a security audit query to the server from the first client, the security audit query including an audit identifier that is shared by the first client and the second client. After receiving a query response from the server, the query response including a copy of the update sequence history maintained by the server, the first client compares the update sequence history in the query response with a copy of corresponding update sequence history maintained by the first client. When the update sequence history in the query response is different from the update sequence history maintained by the first client, the first client marks the data exchange channel as being insecure and terminates. exchanges of further updates to the information item through the data exchange channel with the second client.

### TECHNICAL FIELD

The present application is related generally to computer security technologies and in particular to establishing a secure data exchange channel that can prevent man-in-the-middle attacks by verifying the channel's security using audit queries from a user of the channel in an anonymous manner.

### BACKGROUND

In cryptography and computer security, a man-in-the-middle (MITM) attack is an attack in which the attacker secretly relays and possibly alters the data exchanged between two parties who believe they are directly communicating with each other or indirectly communicating each other via a third-party that does not compromise the security of the data communication. MITM attack is a big challenge for people to accept the on-line data hosting services provided by different vendors since there is no technical guarantee that a service vendor itself cannot access the data it hosts.

### SUMMARY

An object of the present application is to provide a secure data exchange channel that can prevent man-in-the-middle attacks by verifying the channel's security using audit queries from a user of the channel in an anonymous manner.

According to a first aspect of the present application, a method is provided for verifying a data exchange channel between a first client, a second client, and a server that is communicatively coupled to the first client and the second client, respectively. After the first client exchanges a sequence of updates to an information item with the second client through the data exchange channel, each of the first client, the second client, and the server maintains a respective copy of update sequence history of the information item. In order to verify the security of the data exchange channel, the first client sends a security audit query to the server, the security audit query including an audit identifier that is shared by the first client and the second client. Next, the first client receives a query response from the server, the query response including a copy of the update sequence history maintained by the server. The first client then compares the update sequence history in the query response with a copy of corresponding update sequence history maintained by the first client. When the update sequence history in the query response is different from the update sequence history maintained by the first client, the first client marks the data exchange channel as being insecure and terminates exchanges of further updates to the information item through the data exchange channel with the second client.

According to a second aspect of the present application, a first client comprises one or more processors, memory and a plurality of program modules stored in the memory that, when executed by the one or more processors, perform a plurality of operations as described above.

According to a third aspect of the present application, a computer program product stored in a non-transitory computer-readable medium in conjunction with a first client having one or more processors comprises a plurality of program modules that, when executed by the one or more processors, perform a plurality of operations as described above.

### BRIEF DESCRIPTION OF DRAWINGS

The accompanying drawings, which are included to provide a further understanding of the embodiments and are incorporated herein and constitute a part of the specification, illustrate the described embodiments and together with the description serve to explain the underlying principles. Like reference numerals refer to corresponding parts.

FIG. 1 is a block diagram of a client-server computer network environment in accordance with an illustrative embodiment of the present application.

FIG. 2 is a block diagram illustrating components of a computing device in accordance with an illustrative embodiment of the present application.

FIGS. 3A-3J are block diagrams illustrating different data exchange scenarios between first and second clients through a server in accordance with an illustrative embodiment.

FIG. 4 is a flowchart of data exchanges between the two clients and the server in accordance with an illustrative embodiment.

FIGS. 5A-5C are flowcharts of the first client verifying the data exchange channel in accordance with an illustrative embodiment.

### DETAILED DESCRIPTION OF EMBODIMENTS

Reference will now be made in detail to embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. With reference now to the figures, exemplary block diagrams of data processing environments are provided in which illustrative embodiments may be implemented. It should be appreciated that these figures are only exemplary and are not intended to assert or imply any limitation with regard to the environments in which different embodiments may be implemented. Many modifications to the depicted environments may be made.

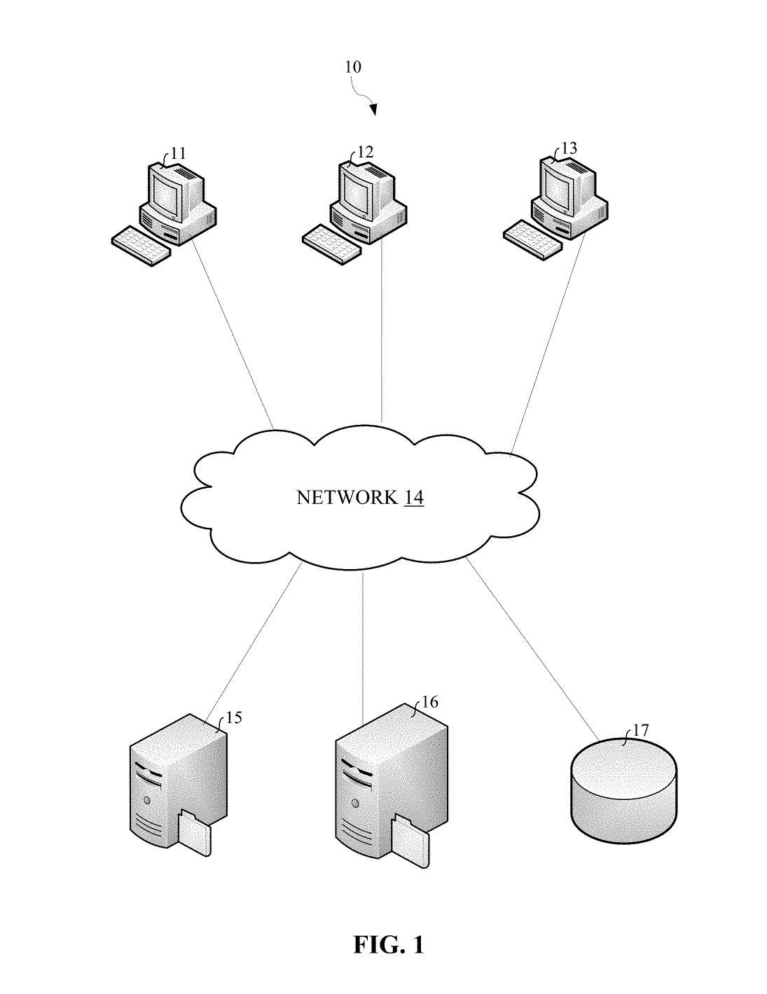

FIG. 1 depicts a block diagram of a client-server computer network environment in accordance with an illustrative embodiment of the present application. The network environment 10 includes a network 14, which is the medium used to provide communications links between various computing devices and computer servers connected together within the network environment 10. The network 14 may include connections, such as wire, wireless communication links, or fiber optic cables.

In the depicted example, servers 15 and 16 connect to the network 14 along with a storage unit 17. In addition, clients 11, 12, and 13 connect to the network 14. Clients 11, 12, and 13 may take the form of a laptop computer, a desktop computer, a tablet computer, a mobile phone (such as a smartphone), a multimedia player device, a navigation device, an educational device (such as a child's learning toy), a gaming station, or a control device (e.g., a home or industrial controller). In the depicted example, the servers 15 and 16 provide data, such as files, images, and applications to the clients 11, 12, and 13. The network environment 10 may include additional servers, clients, and other devices not shown.

In the depicted example, the network environment 10 is the Internet with the network 14 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of tens of thousands of commercial, governmental, educational and other computer systems that route data packets. The network environment 10 also may be implemented as a number of different types of networks, such as for example, an intranet, network (LAN), or a wide area network (WAN). Note that FIG. 1 is intended as an example, and not as an architectural limitation for the different illustrative embodiments.

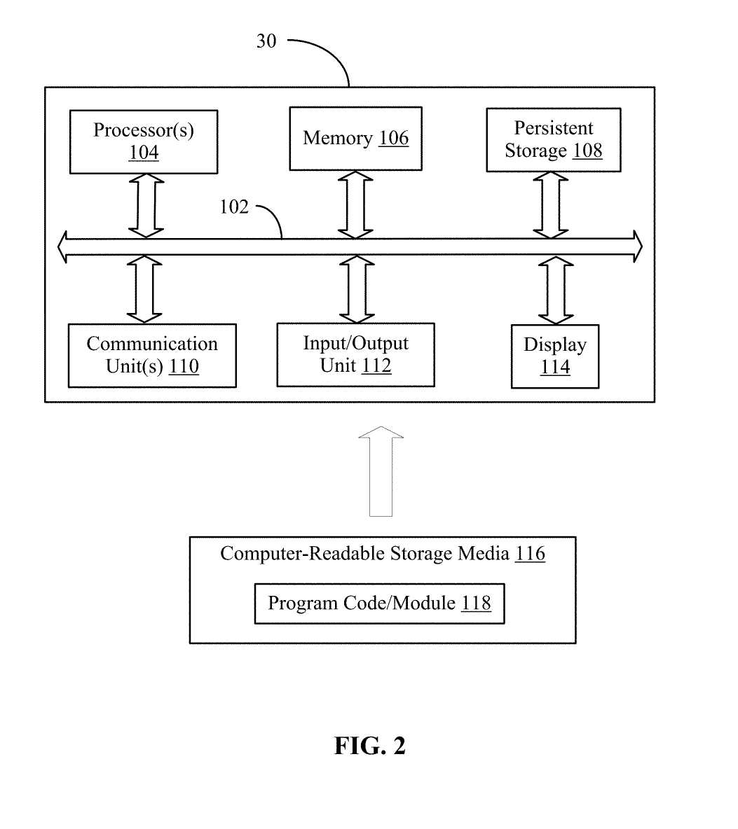

In some embodiments, the server 15 exchanges a large number of data packets with the other server-side components such as the server 16 or the storage unit 17 to provide services to end users at one or more of the clients 11, 12, and 13. FIG. 2 is a block diagram illustrating components of a computing device acting as a client in accordance with an illustrative embodiment of the present application. In this illustrative example, the computing device 30 includes the communications fabric 102, which provides communications between a processor 104, memory 106, a persistent storage 108, a communications unit 110, an input/output (I/O) unit 112, and a display 114. In some embodiments, the computing device 30 may take the form of a laptop computer, a desktop computer, a tablet computer, a smartphone, etc.

The processor 104 serves to execute instructions for software programs that may be loaded into the memory 106. The processor 104 may be a set of one or more processors or may be a multi-processor core, depending on the particular implementation. Further, the processor 104 may be implemented using one or more heterogeneous processor systems in which a main processor is present with secondary processors on a single chip. As another illustrative example, the processor 104 may be a symmetric multi-processor system containing multiple processors of the same type.

The memory 106, in these examples, may be a random access memory or any other suitable volatile or non-volatile storage device. The persistent storage 108 may take various forms depending on the particular implementation. For example, the persistent storage 108 may contain one or more components or devices such as a hard drive, a flash memory, a rewritable optical disk, a rewritable magnetic tape, or some combination of the above. The media used by the persistent storage 108 may also be removable. For example, a removable hard drive may be used for the persistent storage 108.

The communications units 110 provides for communications with other servers or computing devices. The communications units 110 may provide communications through the use of either or both physical and wireless communications links.

The input/output unit 112 allows for input and output of data with other devices that may be connected to the computing device 30. For example, the input/output unit 112 may provide a connection for user input through a keyboard and mouse. Further, the input/output unit 112 may send output to a printer. The display 114 provides a mechanism to display information to a user.

Instructions for the operating system and applications or programs are stored in the persistent storage 108. These instructions may be loaded into the memory 106 for execution by the processor 104. The processes of the different embodiments as described below may be performed by the processor 104 using computer implemented instructions, which may be located in memory, such as the memory 106. These instructions are referred to as program code (or module), computer usable program code (or module), or computer readable program code (or module) that may be read and executed by a processor in the processor 104. The program code (or module) in the different embodiments may be embodied on different physical or tangible computer readable media, such as the memory 106 or the persistent storage 108.

The program code/module 118 is located in a functional form on the computer readable storage media 116 that is selectively removable and may be loaded onto or transferred to the computing device 30 for execution by the processor 104. The program code/module 118 and the computer readable storage media 116 form a computer program product. In one example, the computer readable storage media 116 may be in a tangible form, such as, for example, an optical or magnetic disc that is inserted or placed into a drive or other device that is part of the persistent storage 108 for transfer onto a storage device, such as a hard drive that is part of the persistent storage 108. In a tangible form, the computer readable storage media 116 may also take the form of a persistent storage, such as a hard drive, a thumb drive, or a flash memory that is connected to the computing device 30. The tangible form of the computer readable storage media 116 is also referred to as computer recordable storage media. In some instances, the computer readable storage media 116 may not be removable from the computing device 30.

In some other embodiments, the program code/module 118 may be transferred to the computing device 30 from the computer readable storage media 116 through a communications link to the communications units 110 and/or through a connection to the input/output unit 112. The communications link and/or the connection may be physical or wireless in the illustrative examples. The computer readable storage media 116 also may take the form of non-tangible media, such as communications links or wireless transmissions containing the program code/module.

The different components illustrated for the computing device 30 are not meant to provide architectural limitations to the manner in which different embodiments may be implemented. The different illustrative embodiments may be implemented in a computer system including components in addition to or in place of those illustrated for the computing device 30. Other components shown in FIG. 2 can be varied from the illustrative examples shown.

As one example, a storage device in the computing device 30 is any hardware apparatus that may store data. The memory 106, the persistent storage 108 and the computer readable storage media 116 are examples of storage devices in a tangible form. In another example, a bus system may be used to implement the communications fabric 102 and may be comprised of one or more buses, such as a system bus or an input/output bus. The bus system may be implemented using any suitable type of architecture that provides for a transfer of data between different components or devices attached to the bus system. Additionally, a communications unit may include one or more devices used to transmit and receive data, such as a modem or a network adapter. Further, memory may be, for example, the memory 106 or a cache such as found in an interface and memory controller hub that may be present in the communications fabric 102.

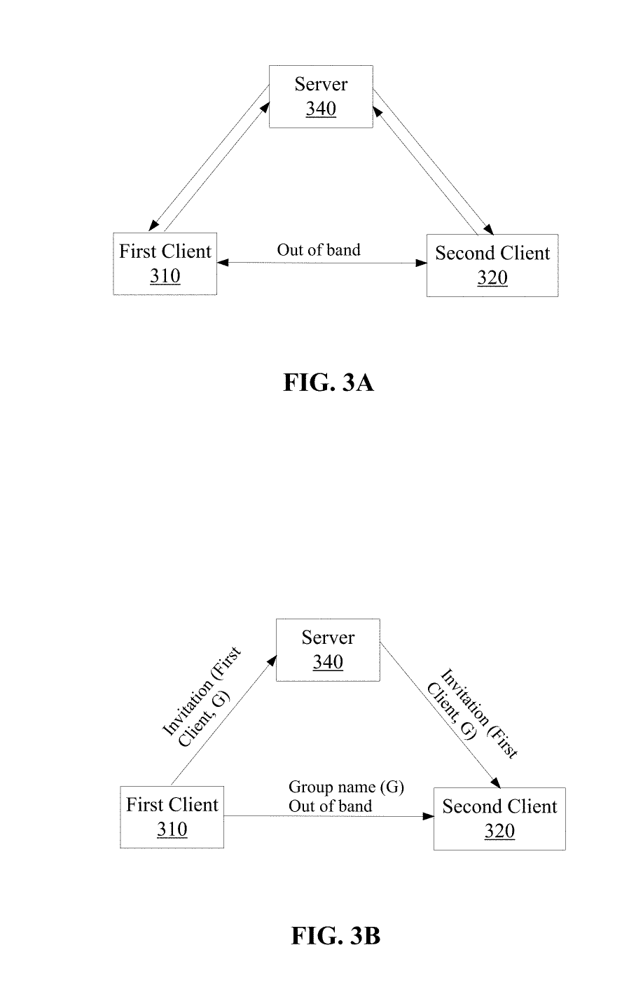

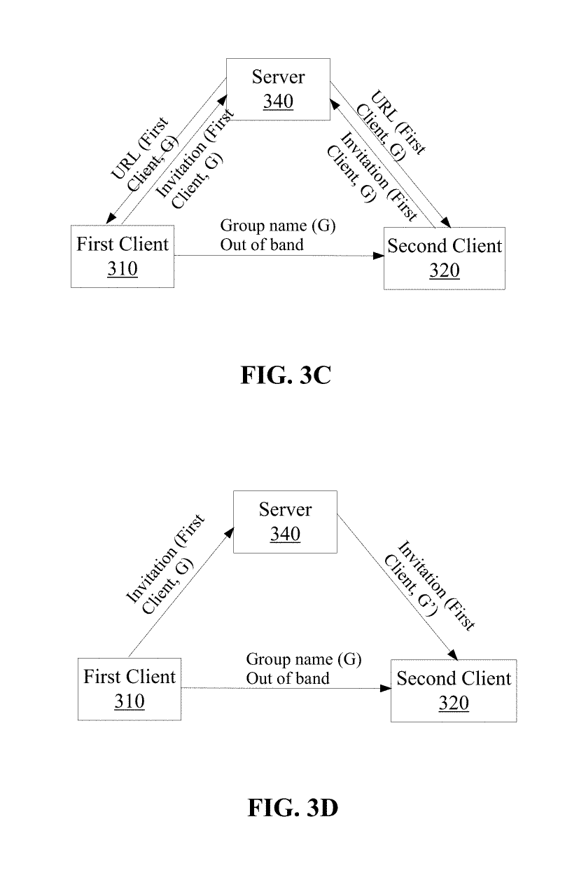

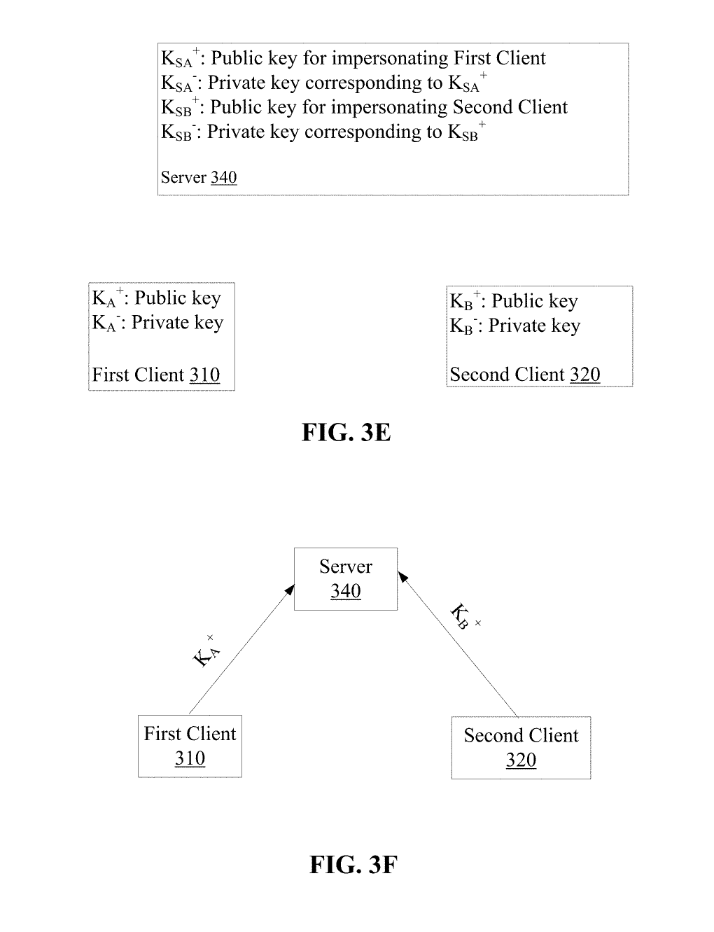

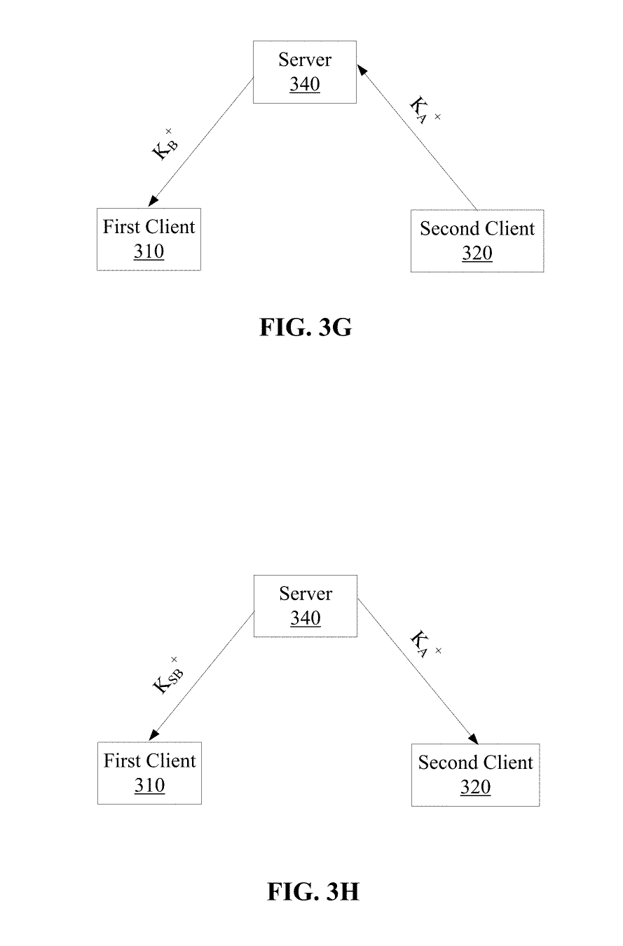

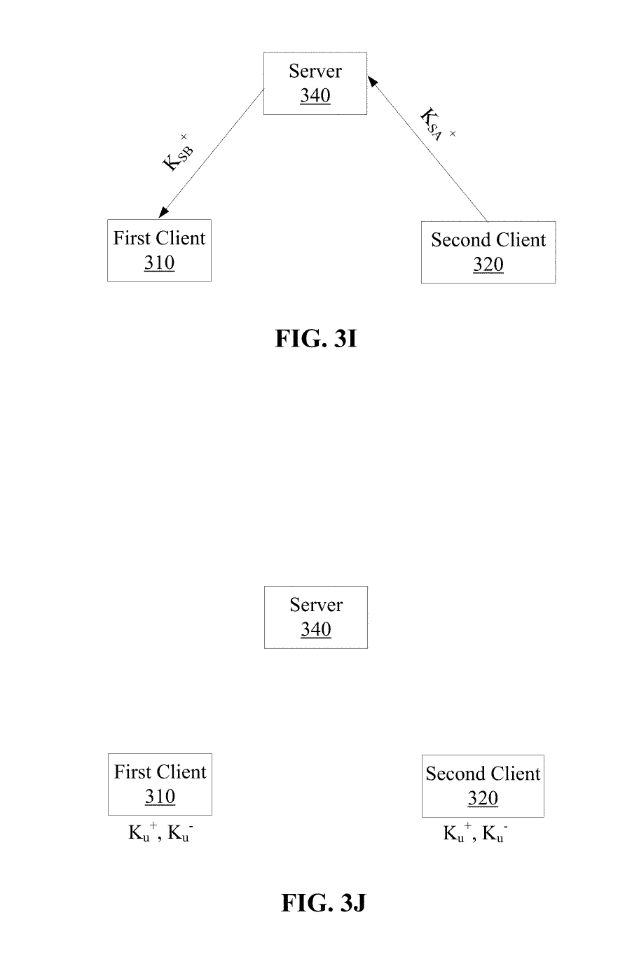

In the context of computer network security, the network environment 10 can be further simplified into a server that is communicatively coupled to two clients and the two clients exchange data with each other through a data exchange channel via the server. FIGS. 3A-3J are block diagrams illustrating different data exchange scenarios between the first and second clients through the server in accordance with an illustrative embodiment.

As shown in FIG. 3A, a user of First client 310 would like to communicate securely with a user of Second client 320. For example, the two users may work on the same document. After one of the two users enters his/her edits into the document. The user would like to share the modified document with the other user at the other client through Server 340. After receiving the modified document from Server 340, the other user can enter his/her changes and return the further modified document to the first user through Server 340. As noted above, a challenge in this process is that the users at First client 310 and Second client 320 may not trust the party that manages Server 340. In other words, the two users have a legitimate concern that the party at Server 340 might launch Man-In-The-Middle attacks to spy on their communications.

One aspect of the present application is to introduce a protocol for establishing a secure data exchange channel between First client 310 and Second client 320 (on one side) and Server (on the other side). The protocol includes two steps: (i) establish a unique channel between First client 310 and Second client 320; and (ii) implement a security verification mechanism in such channel so that Server 340 cannot spy on the communication on this channel.

Besides the data exchange channel involving Server 340, there is also an out-of-band data exchange channel (online or offline) between the user of First client 310 and the user of Second client 320 so that they can exchange some simple information with each other. For example, the user of First client 310 can call the user of Second client 320 to pass on information. The user at First client 310 can use Instant Messaging (IM) to pass on information to the user of Second client 320. The user at First client 310 can send a snail-mail to the user of Second client 320.

Step 1: Establish a Unique Channel Between First Client 310 and Second Client 320.

When the user of First client 310 wants to communicate securely with the user of Second client 320 via Server 340, she needs to establish a unique channel. In some embodiments, this channel is identified by a unique Uniform Resource Locator (URL), so that both First client 310 and Second client 320 will use this unique URL to communicate between them. Assuming the user of First client 310 wants to initiate the channel, she needs to choose a group name (G) and is therefore the owner of this group. The URL is uniquely determined by two factors: the group owner (the user of First client 310) and the group name (G). In some embodiments, URL=H(First client 310, G), where H( ) is a hash function, which creates a unique hash using inputs: the group owner (the user of First client 310) and the group name (G).

As shown in FIG. 3B, once the user of First client 310 chooses the group name (G), she uses the out-of-band channel to notify the user of Second client 320 of the group name (G). For instance, the user of First client 310 can call the user of Second client 320 to tell him the group name she chose. Note that the group name is public information. The out-of-band channel does not need to be secure. The only requirement is that the out-of-band channel has to be reliable so that the user of Second client 320 can receive the actual group name.

In the present application, First client 310 uses Server 340 to establish a secure data exchange channel with Second client 320 for future data exchanges between the two users. First client 310 sends an invitation (I) via Server 340 to Second client 320, inviting Second client 320 to join a group named G, established by the group owner (the user of First client 310).

As shown in FIG. 3C, the user of Second client 320 has two sources of information regarding the group name: (i) through Server 340, i.e., the invitation; and (ii) directly from the user of First client 310 through the out-of-band channel. The user of Second client 320 can verify whether the group names from two sources match each other or not. If the group names from two sources match, Second client 320 will accept the invitation. A unique URL between First client 310 and Second client 320 is then established by Server 340.

On the other hand, if Server 340 intends to attack the proposed data exchange channel between First client 310 and Second client 320, it may change the group name from G to G′. But as shown in FIG. 3D, the user of Second client 320 will notice that the group names (G and G′) from two sources are different. He can then tell that the data exchange channel is under attack and reject the invitation. Moreover, the user can also contact the user of First client 310 via the out-of-band channel that the proposed data exchange channel is compromised and should be abandoned.

In the following sections, it is assumed that the group names from two sources are the same, and therefore a unique URL between First client 310 and Second client 320 via Server 340 has been established.

Step 2: Implement a security verification mechanism in such channel so that Server 340 cannot spy on the communication on this channel.

As shown in FIG. 3E, the security verification mechanism assumes that there are possibly four sets of public-private key-pairs involved in the operations of the channel.
First client 310:
   K_{A}⁺: public key for First client 310, used by anyone who wants to send a message to First client 310 to encrypt that message, so that only First client 310 can decrypt it.
   K_{A}⁻: private key for First client 310, used by First client 310 to decrypt and message encrypted by
Second client 320:
   K_{B}⁺: public key for Second client 320, serving similar purpose like
   K_{B}⁻: private key for Second client 320, serving similar purpose like K_{A}⁻.
Server 340:
   K_{SA}⁺: a public key created by Server 340 to impersonate First client 310
   K_{SA}⁻: a private key created by Server 340 to decrypt messages encrypted by K_{SA}⁺
   K_{SB}⁺: a public key created by Server 340 to impersonate Second client 320
   K_{SB}⁻: a private key created by Server 340 to decrypt messages encrypted by K_{SB}⁺

Note that the first two key-pairs are required for the two clients to exchange data via the data exchange channel securely and the last two key-pairs may or may not exist depending on whether the party managing Server 340 plans to launch any MITM attacks or not. But even if they exist, their existence is assumed to be invisible to the users of the clients. In this present application, a method is proposed for a client to verify their existence and therefore ensure the security of the data exchange channel.

Private keys: K_{A}⁻, K_{B}⁻, K_{SA}⁻, and K_{SB}⁻ can be used to sign a message. The digital signature can only be verified with corresponding public keys: K_{A}⁺, K_{B}⁺, K_{SA}⁺, and K_{SB}⁺. As shown in FIG. 3F, First client 310 and Second client 320 will upload their public keys K_{A}⁺ and K_{B}⁺ to Server 340. In order to communicate securely with each other, First client 310 and Second client 320 query Server 340 for each other's public key. Depending on whether Server 340 wants to attack the data exchange channel between First client 310 and Second client 320. It can respond to First client 310's and Second client 320's queries in one of three ways:

A: Server 340 sends K_{A}⁺ to Second client 320, and K_{B}⁺ to First client 310 as shown in FIG. 3G.

Under scenario A, as First client 310 has Second client 320's public key K_{B}⁺, she can encrypt her message to Second client 320 using K_{B}⁺, Server 340 will not be able to decrypt it. Similarly, Second client 320 will be able to encrypt his message to First client 310 using K_{A}⁺, and Server 340 will not be able to decrypt it either. The data exchange channel between First client 310 and Second client 320 is secure and confidential. In other words, it is assumed that there is no security issue for the data exchange channel between First client 310 and Second client 320 caused by Server 340.

B: Without loss of generality, Server 340 sends K_{A}⁺ to Second client 320, but K_{SB}⁺ to First client 310 as shown in FIG. 3H.

Under scenario B, First client 310 creates a payload in the form of a commit in a Distributed Version Control System (DVCS), such as git that creates a path-dependent history of data exchanges like chained events. In some embodiments, the path-dependent history of data exchanges records a sequence of updates to an information item (e.g., a document) by different clients at different times. Specifically, First client 310 will perform the following steps:
1. First client 310 picks a message M1;
2. First client 310 encrypts M1 using K_{SB}⁺: {M₁}_{K}_{_{SB}}_{⁺};
3. First client 310 signs the encrypted M1 using K_{A}⁻:

$${\{ {\{ {M}_{1} \}}_{{K}_{SB}^{+}} \}}_{{K}_{A}^{-}} ;$$

4. First client 310 creates a git commit C1, based on the encrypted and signed M1:

$${C}_{1} ( {\{ {\{ {M}_{1} \}}_{{K}_{SB}^{+}} \}}_{{K}_{A}^{-}} ) ;$$

and
5. First client 310 pushes C1 to Server 340 at the unique URL.

If Server 340 does not change C1 and keeps it as is, Second client 320 will fetch C1 from the unique URL, and perform the following actions:
1. Second client 320 checks out C1 to get its content:

$${\{ {\{ {M}_{1} \}}_{{K}_{SB}^{+}} \}}_{{K}_{A}^{-}} ;$$

2. Second client 320 uses K_{A}⁺ to verify First client 310's signature, and gets the encrypted message:{M₁}_{K}_{_{SB}}_{⁺}; and
3. Second client 320 tries to decrypt the encrypted message using K_{B}⁻. It will fail as the encryption is done using K_{SB}⁺, not K_{B}⁺.

At this moment, Second client 320 will know the data exchange channel is compromised. Its user can then notify the user of First client 310 about the compromise using the out-of-band channel.

If Server 340 does change C1, it may do the following:
1. Server 340 checks out C1 to get its content:

$${\{ {\{ {M}_{1} \}}_{{K}_{SB}^{+}} \}}_{{K}_{A}^{-}} ;$$

2. Server 340 uses K_{A}⁺ to verify First client 310's signature, and gets the encrypted message: {M₁}_{K}_{_{SB}}_{⁺};
3. Server 340 decrypts the encryption using K_{SB}⁻ to get M1;
4. Server 340 re-encrypts M1 using K_{B}⁺: {M₁}_{K}_{_{SB}}_{⁺};
5. Server 340 does not have K_{A}⁻, he can only sign encrypted M1, using K_{SA}⁻:

$${\{ {\{ {M}_{1} \}}_{{K}_{B}^{+}} \}}_{{K}_{SA}^{-}} ;$$

and
6. Server 340 creates a git commit C′₁, based on re-encrypted and re-signed M1:

$${C}_{1}^{′} ( {\{ {\{ {M}_{1} \}}_{{K}_{B}^{+}} \}}_{{K}_{SA}^{-}} ) .$$

When Second client 320 tries to fetch a git commit from the unique URL, Server 340 will be able to identify Second client 320 from its ID, and feed Second client 320 the customized commit C′₁. Upon receipt of the customized commit C′₁ Second client 320 will then perform the following actions:
1. Second client 320 fetches C′₁ from the unique URL, provided by Server 340;
2. Second client 320 checks out C′₁ to get its content:

$${\{ {\{ {M}_{1} \}}_{{K}_{B}^{+}} \}}_{{K}_{SA}^{-}} ;$$

and
3. Second client 320 verifies the signature using K_{A}⁺, and it will fail as the encrypted message is signed by K_{SA}⁻, not K_{A}⁻.

Similarly, Second client 320 will also know the data exchange channel is compromised and it can contact the user of First client 310 via the out-of-band channel about the security breach.

In summary, under scenario B, all breaches will be detected and the Man-In-The-Middle attacks by Server 340 will fail.

C: Server 340 sends K_{SA}⁺ to Second client 320, and K_{SB}⁺ to First client 310 as shown in FIG. 3I.

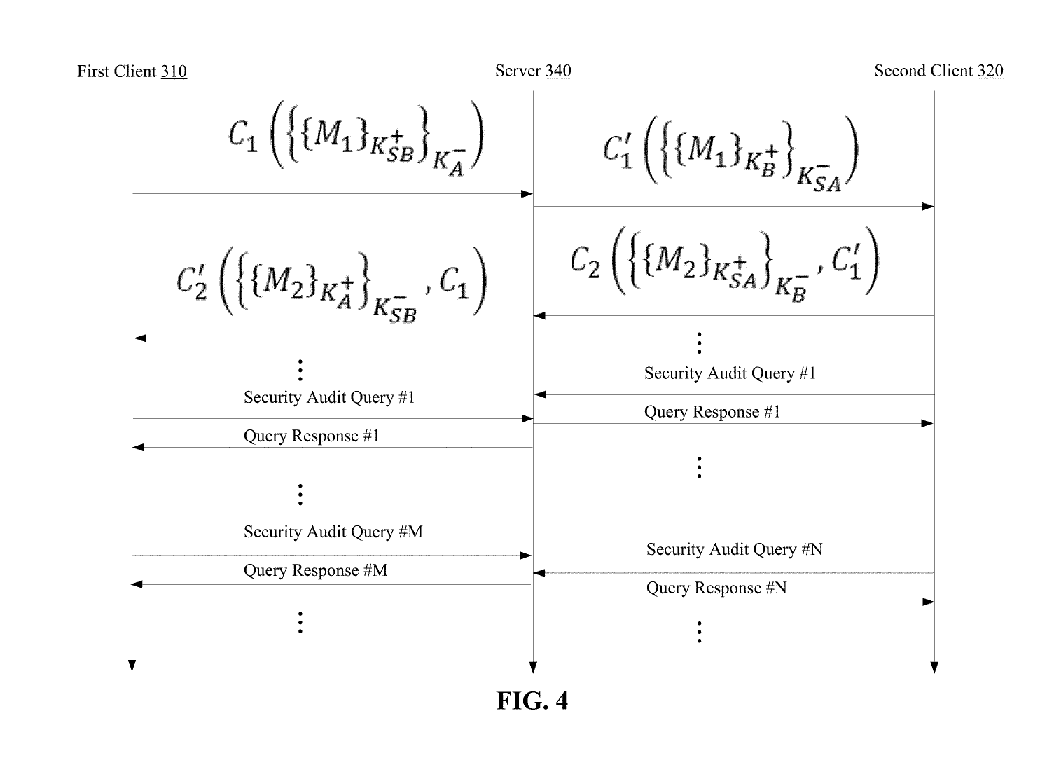

FIG. 4 depicts the exchanges of an encrypted message M1 under scenario C. Initially, First client 310 creates a git commit by performing the following steps:
1. First client 310 picks a message M1;
2. First client 310 encrypts M1 using K_{SB}⁺: {M₁}_{K}_{_{SB}}_{⁺};
3. First client 310 signs encrypted M1, using K_{A}⁻:

$${\{ {\{ {M}_{1} \}}_{{K}_{SB}^{+}} \}}_{{K}_{A}^{-}} ;$$

4. First client 310 creates a git commit C1, based on encrypted and signed M1:

$${C}_{1} ( {\{ {\{ {M}_{1} \}}_{{K}_{SB}^{+}} \}}_{{K}_{A}^{-}} ) ;$$

and
5. First client 310 pushes C1 to Server 340 at unique URL

After Server 340 receives the commit, it may modify the commit to fool Second client 320 by impersonating First client 310 and performing the following steps:
1. Check out C1 to get its content:

$${\{ {\{ {M}_{1} \}}_{{K}_{SB}^{+}} \}}_{{K}_{A}^{-}} ;$$

2. Verify the signature using K_{A}⁺: {M₁}_{K}_{_{SB}}_{⁺};
3. Decrypt the encryption using K_{SB}⁻: M1;
4. Re-encrypt M1 using K_{B}⁺: {M₁}_{K}_{_{SB}}_{⁺};
5. Sign re-encrypted M1 using K_{SA}⁻:

$${\{ {\{ {M}_{1} \}}_{{K}_{B}^{+}} \}}_{{K}_{SA}^{-}} ;$$

and
6. Create a git commit C′₁, based on re-encrypted and re-signed M1:

$${C}_{1}^{′} ( {\{ {\{ {M}_{1} \}}_{{K}_{B}^{+}} \}}_{{K}_{SA}^{-}} ) .$$

When Second client 320 wants to fetch from unique URL, Server 340 can detect Second client 320 via Second client 320's ID, and feed Second client 320 C′₁. Second client 320 then performs the following actions:
1. Second client 320 fetches C′₁ from unique URL, provided by Server 340;
2. Second client 320 checks out C′₁ to get its content:

$${\{ {\{ {M}_{1} \}}_{{K}_{B}^{+}} \}}_{{K}_{SA}^{-}} ;$$

3. Second client 320 verifies the signature using K_{SA}⁺: {M₁}_{K}_{_{SB}}_{⁺}; and
4. Second client 320 decrypts the encryption using K_{B}⁻: M1.

At this point, Second client 320 cannot tell the communication channel has been breached because it is able to receive the message M1 although Server 340 already has access to the message M1 before it does. In other words, so far the Man-In-The-Middle attacks by Server 340 are not yet detected. Second client 320 proceeds by performing the following actions:
1. Second client 320 picks a message M2;
2. Second client 320 encrypts M2 using K_{SA}⁺: {M₂}_{K}_{_{SA}}_{⁺};
3. Second client 320 signs encrypted M2 using K_{B}⁻:

$${\{ {\{ {M}_{2} \}}_{{K}_{SA}^{+}} \}}_{{K}_{B}^{-}} ;$$

4. Second client 320 creates a git commit C2, based on encrypted and signed M2, and C′₁ received from Server 340 in the previous step:

$${C}_{2} ( {\{ {\{ {M}_{2} \}}_{{K}_{SA}^{+}} \}}_{{K}_{B}^{-}} , {C}_{1}^{′} ) ;$$

and
5. Second client 320 pushes C2 to unique URL.

Now, Second client 320 has two chained commits: C′₁, and C2, which in turn depends on C′₁. Once Server 340 receives C2, it then prepares a customized commit for First client 310 by performing the following actions:
1. Server 340 checks out C2, and gets its content:

$${\{ {\{ {M}_{2} \}}_{{K}_{SA}^{+}} \}}_{{K}_{B}^{-}} ;$$

2. Server 340 verifies the signature using K_{B}⁺: {M₂}_{K}_{_{SA}}_{⁺};
3. Server 340 decrypts the encryption using K_{SA}⁻: M2;
4. Server 340 re-encrypts M2 using K_{A}⁺: {M₂}_{K}_{_{SA}}_{⁺};
5. Server 340 re-signs encrypted M2 using K_{SB}⁻:

$${\{ {\{ {M}_{2} \}}_{{K}_{A}^{+}} \}}_{{K}_{SB}^{-}} ;$$

and
6. Server 340 re-creates a git commit C′₂, based on re-encrypted and re-signed M2, and C1, received from First client 310 previously:

$${C}_{2}^{′} ( {\{ {\{ {M}_{2} \}}_{{K}_{A}^{+}} \}}_{{K}_{SB}^{-}} , {C}_{1} ) .$$

When First client 310 tries to fetch from the unique URL, Server 340 can detect First client 310 via its ID, and feed it customized C′₂. First client 310 will fetch, verify, and decrypt the message M2. Until now, the Man-In-The-Middle attacks by Server 340 are not yet detected.

After this point, the applications on both First client 310 and Second client 320 will periodically and randomly launch a series of audit operations as shown in FIG. 4. Each client has its own set of public-private key-pair. In order to verify whether the data exchange channel has been compromised by Server 340, both First client 310 and Second client 320 have the same auditor account and therefore the same pair of keys (Kᵤ⁺, Kᵤ⁻) as shown in FIG. 3J. The objective of the auditor account is to mask the origin of an audit query, so that Server 340 cannot tell whether First client 310 or Second client 320 is launching a security audit operation. When one of the two clients is launching an operation, it sends the same query request for the head commit at the unique URL, i.e., the sequence of updates to an information item (e.g., the message.

As noted above, Server 340 maintains two separate git reports customized for First client 310 (C1, C′₂) and Second client 320 (C′₁, C2) in order to hide the fact that it has compromised the security of the data exchange channel at the unique URL. To do so, it has to First client 310 and Second client 320 the “right” git report as long as Server 340 can tell the identity of the client submitting the audit query. But when Server 340 receives a query from an auditor account, it has no way of telling whether First client 310 or Second client 320 is behind the audit operation. Therefore, for each audit operation, Server 340 has only 50 percent chance of returning the correct git report. If either First client 310 or Second client 320 launches continuously audit queries, it can quickly achieve a desired level of confidence that the right answer from Server 340 was not caused by chance.

Taking First client 310 as an example, if First client 310 launches seven queries, the probability that Server 340 gives right answers to all seven queries is (½)⁷=( 1/128)<1%. In other words, the Man-In-The-Middle attack by Server 340 can be easily captured given the low probability that Server 340 will be able to answer queries correctly.

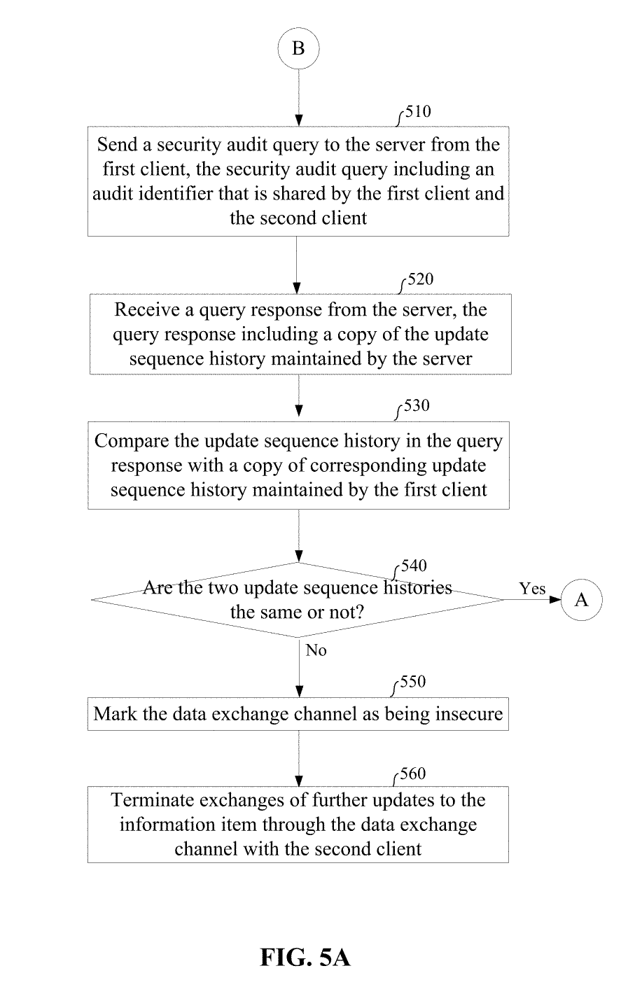

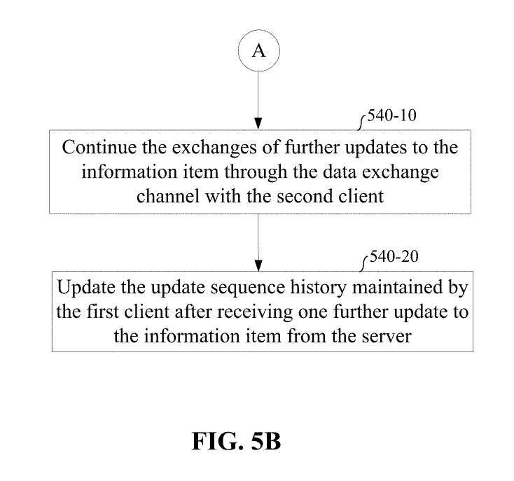

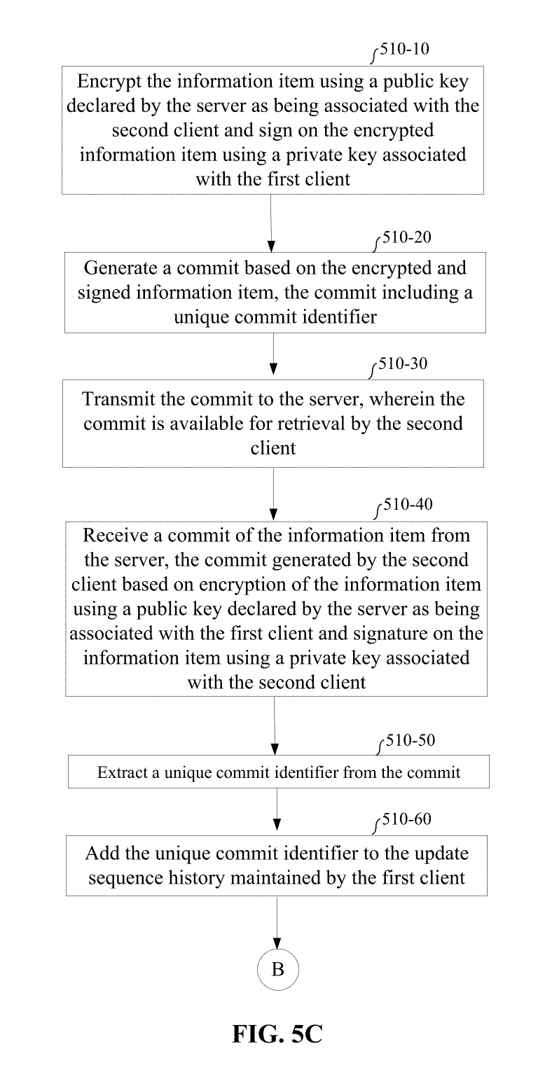

The computer security methodology described above can be summarized by the flowcharts shown in FIGS. 5A-5C illustrating how a first client verifies the data exchange channel it has with a second client through a server in accordance with an illustrative embodiment.

The first client sends (510) a security audit query to the server from the first client, the security audit query including an audit identifier that is shared by the first client and the second client. Next, the first client receives (520) a query response from the server, the query response including a copy of the update sequence history maintained by the server. After comparing (530) the update sequence history in the query response with a copy of corresponding update sequence history maintained by the first client, the first client determines (540) whether the two update sequence histories are the same or not. When the update sequence history in the query response is different from the update sequence history maintained by the first client (540-No), the first client marks (550) the data exchange channel as being insecure and terminates (560) exchanges of further updates to the information item through the data exchange channel with the second client. After learning such security breach, the user of the first client can notify the user of the second client via the out-of-band channel.

Note that as shown in FIG. 4, the first client may repeat the steps shown in FIG. 5A for at least at least a predefined multiple times after the first client receives one or more new updates to the information item from the server. Of course, the first client may stop repeating the steps whenever the update sequence history in a most recent query response is different from the update sequence history maintained by the first client.

In some embodiment shown in FIG. 5B, when the update sequence history in the query response is the same as the update sequence history maintained by the first client (540-Yes), the first client continues (540-10) the exchanges of further updates to the information item through the data exchange channel with the second client and updates (540-20) the update sequence history maintained by the first client after receiving one further update to the information item from the server.

In some embodiments shown in FIG. 5C, the first client performs a set of operations before sending any security audit query to the server. For example, the first client may encrypt (510-10) the information item using a public key declared by the server as being associated with the second client and sign on the encrypted information item using a private key associated with the first client. Next, the first client generates (510-20) a commit based on the encrypted and signed information item, the commit including a unique commit identifier produced by the first client, and transmits (510-30) the commit to the server so that the commit is available for retrieval by the second client.

In some embodiments, the first client also receives (510-40) a commit of the information item from the server. Note that this commit is generated by the second client based on encryption of the information item using a public key declared by the server as being associated with the first client and signature on the information item using a private key associated with the second client. Next, the first client extract (510-50) a unique commit identifier from the commit and adds (510-60) the unique commit identifier to the update sequence history maintained by the first client.

Finally, it should be noted that the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A computer system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the computer system to become coupled to other computer systems or remote printers or storage devices through intervening private or public networks. Modems, cable modem and Ethernet cards are just a few of the currently available types of network adapters.

The description of the present application has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “include”, “including”, ““comprise”, and/or “comprising”, when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first port could be termed a second port, and, similarly, a second port could be termed a first port, without departing from the scope of the embodiments. The first port and the second port are both ports, but they are not the same port.

Many modifications and alternative embodiments of the embodiments described herein will come to mind to one skilled in the art having the benefit of the teachings presented in the foregoing descriptions and the associated drawings. Therefore, it is to be understood that the scope of claims are not to be limited to the specific examples of the embodiments disclosed and that modifications and other embodiments are intended to be included within the scope of the appended claims. Although specific terms are employed herein, they are used in a generic and descriptive sense only and not for purposes of limitation.

The embodiments were chosen and described in order to best explain the underlying principles and their practical applications, to thereby enable others skilled in the art to best utilize the underlying principles and various embodiments with various modifications as are suited to the particular use contemplated.

What is claimed is:

1. A method for verifying a data exchange channel between a first client, a second client, and a server that is communicatively coupled to the first client and the second client, respectively, wherein the first client exchanges a sequence of updates to an information item with the second client through the data exchange channel and each of the first client, the second client, and the server maintains a respective copy of update sequence history of the information item, the method comprising:
sending a security audit query to the server from the first client, the security audit query including an audit identifier that is shared by the first client and the second client;
receiving a query response from the server, the query response including a copy of the update sequence history maintained by the server;
comparing the update sequence history in the query response with a copy of corresponding update sequence history maintained by the first client; and
when the update sequence history in the query response is different from the update sequence history maintained by the first client:
marking the data exchange channel as being insecure; and
terminating exchanges of further updates to the information item through the data exchange channel with the second client.

2. The method of claim 1, further comprising:
when the update sequence history in the query response is the same as the update sequence history maintained by the first client:
continuing the exchanges of further updates to the information item through the data exchange channel with the second client; and
updating the update sequence history maintained by the first client after receiving one further update to the information item from the server.

3. The method of claim 1, wherein the method is repeated for at least at least a predefined multiple times after the first client receives one or more new updates to the information item from the server.

4. The method of claim 3, wherein the method is stopped whenever the update sequence history in a most recent query response is different from the update sequence history maintained by the first client.

5. The method of claim 1, further comprising:
before sending the security audit query to the server:
encrypting the information item using a public key declared by the server as being associated with the second client;
signing on the encrypted information item using a private key associated with the first client;
generating a commit based on the encrypted and signed information item, the commit including a unique commit identifier; and
transmitting the commit to the server, wherein the commit is available for retrieval by the second client.

6. The method of claim 1, further comprising:
before sending the security audit query to the server:
receiving a commit of the information item from the server, wherein the commit is generated by the second client based on encryption of the information item using a public key declared by the server as being associated with the first client and signature on the information item using a private key associated with the second client;
extracting a unique commit identifier from the commit; and
adding the unique commit identifier to the update sequence history maintained by the first client.

7. A first client that has a data exchange channel with a second client via a server that is communicatively coupled to the first client and the second client, respectively, wherein the first client exchanges a sequence of updates to an information item with the second client through the data exchange channel and each of the first client, the second client, and the server maintains a respective copy of update sequence history of the information item, the first client comprising:
one or more processors;
memory; and
a plurality of program modules stored in the memory that, when executed by the one or more processors, perform a plurality of operations comprising:
sending a security audit query to the server from the first client, the security audit query including an audit identifier that is shared by the first client and the second client;
receiving a query response from the server, the query response including a copy of the update sequence history maintained by the server;
comparing the update sequence history in the query response with a copy of corresponding update sequence history maintained by the first client; and
when the update sequence history in the query response is different from the update sequence history maintained by the first client:
marking the data exchange channel as being insecure; and
terminating exchanges of further updates to the information item through the data exchange channel with the second client.

8. The first client of claim 7, wherein the plurality of operations further include:
when the update sequence history in the query response is the same as the update sequence history maintained by the first client:
continuing the exchanges of further updates to the information item through the data exchange channel with the second client; and
updating the update sequence history maintained by the first client after receiving one further update to the information item from the server.

9. The first client of claim 7, wherein the plurality of operations are repeated for at least at least a predefined multiple times after the first client receives one or more new updates to the information item from the server.

10. The first client of claim 9, wherein the plurality of operations are stopped whenever the update sequence history in a most recent query response is different from the update sequence history maintained by the first client.

11. The first client of claim 7, wherein the plurality of operations further include:
before sending the security audit query to the server:
encrypting the information item using a public key declared by the server as being associated with the second client;
signing on the encrypted information item using a private key associated with the first client;
generating a commit based on the encrypted and signed information item, the commit including a unique commit identifier; and
transmitting the commit to the server, wherein the commit is available for retrieval by the second client.

12. The first client of claim 7, wherein the plurality of operations further include:
before sending the security audit query to the server:
receiving a commit of the information item from the server, wherein the commit is generated by the second client based on encryption of the information item using a public key declared by the server as being associated with the first client and signature on the information item using a private key associated with the second client;
extracting a unique commit identifier from the commit; and
adding the unique commit identifier to the update sequence history maintained by the first client.

13. A computer program product stored in a non-transitory computer-readable medium in conjunction with a first client that has a data exchange channel with a second client via a server that is communicatively coupled to the first client and the second client, respectively, wherein the first client exchanges a sequence of updates to an information item with the second client through the data exchange channel and each of the first client, the second client, and the server maintains a respective copy of update sequence history of the information item, the first client having one or more processors, the computer program product comprising a plurality of program modules that, when executed by the one or more processors, perform a plurality of operations comprising:
sending a security audit query to the server from the first client, the security audit query including an audit identifier that is shared by the first client and the second client;
receiving a query response from the server, the query response including a copy of the update sequence history maintained by the server;
comparing the update sequence history in the query response with a copy of corresponding update sequence history maintained by the first client; and
when the update sequence history in the query response is different from the update sequence history maintained by the first client:
marking the data exchange channel as being insecure; and
terminating exchanges of further updates to the information item through the data exchange channel with the second client.

14. The computer program product of claim 13, wherein the plurality of operations further include:
when the update sequence history in the query response is the same as the update sequence history maintained by the first client:
continuing the exchanges of further updates to the information item through the data exchange channel with the second client; and
updating the update sequence history maintained by the first client after receiving one further update to the information item from the server.

15. The computer program product of claim 13, wherein the plurality of operations are repeated for at least at least a predefined multiple times after the first client receives one or more new updates to the information item from the server.

16. The computer program product of claim 15, wherein the plurality of operations are stopped whenever the update sequence history in a most recent query response is different from the update sequence history maintained by the first client.

17. The computer program product of claim 13, wherein the plurality of operations further include:
before sending the security audit query to the server:
encrypting the information item using a public key declared by the server as being associated with the second client;
signing on the encrypted information item using a private key associated with the first client;
generating a commit based on the encrypted and signed information item, the commit including a unique commit identifier; and
transmitting the commit to the server, wherein the commit is available for retrieval by the second client.

18. The computer program product of claim 13, wherein the plurality of operations further include:
before sending the security audit query to the server:
receiving a commit of the information item from the server, wherein the commit is generated by the second client based on encryption of the information item using a public key declared by the server as being associated with the first client and signature on the information item using a private key associated with the second client;
extracting a unique commit identifier from the commit; and
adding the unique commit identifier to the update sequence history maintained by the first client.
